(19) United States
(12) Patent Application Publication
(10) Pub. No.: US 2025/0043190 A1
(43) Pub. Date: Feb. 6, 2025

(54) METHODS FOR OPTIMIZING FEEDSTOCK IN PYROLYSIS SYSTEMS

(71) Applicant: RJ LEE GROUP, INC., Monroeville, PA (US)

(72) Inventors: Richard J. LEE, Murrysville, PA (US); Duane M. ERICKSON, Natchez, MS (US); Steven J. MONACO, Venetia, PA (US); Alan M. LEVINE, Monroeville, PA (US); Paul J. LEE, Frontenac, MO (US); Alan LEE, Berthold, ND (US); Ervin LEE, Glen Ullin, ND (US); John SHIDE, Natchez, MS (US); Carl PRO, Monroeville, PA (US); Casey BUNKER, Murrysville, PA (US); Ryan BOOTH, Pittsburgh, PA (US)

(21) Appl. No.: 18/791,541

(22) Filed: Aug. 1, 2024

Related U.S. Application Data
(60) Provisional application No. 63/530,206, filed on Aug. 1, 2023.

(51) Int. Cl. C10G 1/10; C10B 49/18; C10B 53/07

(52) U.S. Cl. CPC C10G 1/10; C10B 49/18; C10B 53/07; C10G 2300/1003; C10G 2300/30; C10G 2300/4006; C10G 2300/70

(57) ABSTRACT

The disclosure is generally directed to the field of optimizing feedstock in pyrolysis systems. A method of obtaining pyrolysis oil from a feedstock comprising rubber comprises the steps of: providing a feedstock comprising rubber; milling the feedstock, thereby providing particles; and pyrolyzing the particles in a vessel; wherein the median size of the particles is from about 0.5 mm to about 15 mm, optionally from about 0.5 mm to about 12 mm, optionally from about 0.5 mm to about 9 mm, optionally from about 0.5 mm to about 6 mm, optionally 15 mm or smaller, optionally 12 mm or smaller, optionally 9 mm or smaller, optionally 6 mm or smaller. The feedstock optionally comprises a plurality of tires.

### CROSS-REFERENCE TO RELATED APPLICATIONS

This application claims priority to U.S. Provisional Application No. 63/530,206, filed on Aug. 1, 2023. The aforementioned priority application is hereby incorporated by reference in its entirety.

### FIELD

The disclosure is generally directed to the field of optimizing feedstock in pyrolysis systems.

### BACKGROUND

On average, one discarded tire is generated per person per year in the United States. Discarded tires that are piled on a property pose significant hazards. These piles can become hazardous, both due to their pollution of the surroundings and their nature as breeding grounds for snakes and vermin. Furthermore, fires that are caused by ignition of waste tires, which can be difficult to extinguish, are detrimental to air quality. For these and other reasons, the safe and economical disposal of waste tires has become a significant world-wide problem.

Tire pyrolysis is gaining acceptance as a means of disposing of waste tires in an environmentally sustainable manner. The primary byproducts of the pyrolysis of tires are carbon char and pyrolysis oil (TPO). These primary products have little economic value, and it is difficult to operate such an operation in a profitable manner. The use of catalysts (U.S. Pat. Nos. 6,833,485, 6,835,861, and 7,341,646) has lowered operating costs and made the process more economical.

Addition of a catalyst to the surface of rubber particles can reduce the temperature required to depolymerize (“DEP”) the rubber. However, while inclusion of a catalyst can provide benefit, it complicates the feed system and can increase the rate of failures in the reactor. Also, current practice is to add the catalyst in a separate stream from the rubber feed, which necessarily allows air to enter the reaction chamber. This stresses the vacuum system, thereby complicating maintenance and increasing operating costs. At increased vapor flow, fine carbon is carried over into the vapor stream, ultimately ending up in the TPO and reducing its value.

### SUMMARY

Disclosed herein is an innovative method to improve tire life cycle management to both reduce CO₂ emissions and optimize the waste tire feedstock to increase throughput in pyrolysis reactors, minimize carbon grinding, and improve the quality of the output recovered carbon black (rCB) and tire pyrolysis oil (TPO), or DEPolymerization Liquid (DPL).

In particular, the tire is recycled by fragmenting into small pieces, of the order of 15 mm or smaller, in contrast to current practice. The fragments are then pyrolyzed, to afford higher quality carbon and/or pyrolysis oil accompanied by more favorable economics.

Although certain methods disclosed herein may be particularly useful for feedstocks comprising a plurality of tires, the disclosure should not be construed as limiting to tire-based sources of rubber. The methods may also be valuable for feedstocks comprising a mixture of tires and non-tire material. The methods may also be valuable for feedstocks consisting exclusively of non-tire material.

Provided is a method of obtaining pyrolysis oil from rubber, comprising the steps of:
providing a feedstock, said feedstock comprising rubber;
milling the feedstock, thereby providing particles of the feedstock; and
pyrolyzing the particles in a vessel;
wherein the median size of the particles is from about 0.5 mm to about 15 mm, optionally from about 0.5 mm to about 12 mm, optionally from about 0.5 mm to about 9 mm, optionally from about 0.5 mm to about 6 mm. optionally 15 mm or smaller, optionally 12 mm or smaller, optionally 9 mm or smaller, optionally 6 mm or smaller.

In some embodiments, the feedstock comprises a plurality of tires.

In some embodiments, the method further provides recovered carbon black (“rCB”).

In some embodiments, the method further includes a step, subsequent to fragmentation, of removing wire. In some embodiments, the method further includes the step, subsequent to fragmentation, of removing fiber. In some embodiments, the step further includes the step, subsequent to fragmentation, of removing minerals. Each of these steps can provide an economic or environmental benefit, as detailed further below.

In some embodiments, the pyrolysis step is performed in the presence of a catalyst.

In some embodiments, the catalyst comprises a clay. In further embodiments, the clay is chosen from bentonite, montmorillonite, and beidellite.

In some embodiments, the catalyst comprises a metal dust. In further embodiments, the metal dust comprises aluminum or magnesium.

In some embodiments, the method further comprising the step of mixing the catalyst with the feedstock prior to milling the feedstock.

In some embodiments, the method further comprises the step of mixing the catalyst with the particles prior to introduction of the particles into the vessel.

In some embodiments, the particles reach a target temperature at a rate that is 200% or faster, optionally 300% or faster, optionally 400% or faster, than the corresponding rate for 20 mm particles.

In some embodiments, the pyrolysis step is performed with an auger. In further embodiments, the heat flux is 125% or faster, optionally 150% or faster, optionally 200% or faster, than the corresponding rate for 20 mm particles.

In some embodiments, the feedstock comprises a plurality of tires. In further embodiments, the method further provides recovered carbon black (“rCB”).

In some embodiments, the method further comprises the step of removing polymer fiber from the feedstock subsequent to the step of milling the feedstock.

In some embodiments, 70% or more of the polymer fiber is removed from the feedstock, optionally 80% or more, optionally 90% or more.

In some embodiments, between 70% and 95% of the polymer fiber is removed from the feedstock, optionally between 80% and 95%, optionally between 85% and 95%.

In some embodiments, polymer fiber is removed using density separation.

In some embodiments, the method further comprises the step of separating a component of the tire chosen from the tread, the sidewall, and the inner liner, subsequent to the step of milling the feedstock. In further embodiments, the component of the tire is the tread. In yet further embodiments, the step of separating the tread is performed using buffing.

In some embodiments, the method further comprises the step of removing metal wire subsequent to the step of milling the feedstock. In further embodiments, the metal wire comprises steel. In yet further embodiments, the metal wire is removed using magnetic separation.

In some embodiments, the method further comprises the step of removing one or more minerals subsequent to the step of milling the feedstock.

In some embodiments, the one or more minerals comprise compounds or oxides of sulfur, zinc sulfide, calcium, titanium, or a mixture thereof.

In some embodiments, minerals are removed using density separation or treatment with an acid. In further embodiments, the acid is a mineral acid. In yet further embodiments, the mineral acid is chosen from hydrochloric acid, sulfuric acid, and nitric acid.

### BRIEF DESCRIPTION OF THE DRAWINGS

A full understanding of the invention can be gained from the following description of the preferred embodiments when read in conjunction with the accompanying drawings in which:

FIG. 1 depicts the heating profile of a single solid particle according to a Lumped Capacitance Model. y-axis: temperature (arbitrary units); x-axis: time (arbitrary units); Tₘ: maximum temperature; Tₜ: temperature at arbitrary time t; T₀: original temperature;

FIG. 2 depicts the heating profiles of a number of spherical particles of various radii (a) 2 mm (b) 6 mm (c) 10 mm (d) 14 mm (e) 18 mm (f) 22 mm, according to a finite element analysis; x-axis: time (min); y-axis: temperature (K);

FIG. 3 depicts heat flux over time for (a) 20 mm and (b) 6 mm particles in an Auger system, according to a finite element analysis; x-axis: time (sec), y-axis: heat flux (W/m² kg); and; and

FIG. 4 depicts the heating profile over time for (a) 20 mm and (b) 6 mm particles in an Auger system, according to a finite element analysis; x-axis: axial position (m); y-axis: average particle temperature (K).

### DETAILED DESCRIPTION

While the general inventive concepts are susceptible of embodiment in many forms, there are shown in the drawings, and will be described herein in detail, specific embodiments thereof with the understanding that the present disclosure is to be considered an exemplification of the principles of the general inventive concepts. Accordingly, the general inventive concepts are not intended to be limited to the specific embodiments illustrated herein.

It is also to be understood that the terminology used herein is for the purpose of describing particular embodiments only, and is not intended to be limiting.

The articles “a” and “an” are used herein to refer to one or more than one (i.e., to at least one) of the grammatical object of the article. By way of example, “a cell” means one cell or more than one cell.

“About” as used herein when referring to a measurable value such as an amount, a temporal duration, and the like, is meant to encompass variations of ±5%, preferably ±1%, and still more preferably ±0.1% from the specified value, as such variations are appropriate to perform the disclosed methods.

In some embodiments of any of the compositions or methods described herein, a range is intended to comprise every integer or fraction or value within the range.

Embodiments described herein as “comprising” one or more features may also be considered as disclosure of the corresponding embodiments “consisting of” and/or “consisting essentially of” such features.

Unless otherwise noted, the term “median size of tire particles,” as used herein, refers to the median value for the shortest cross-sectional dimension for the tire particles. In some embodiments, the term refers to a sieve size through which 85% or more, optionally 90% or more, optionally 95% or more of a quantity of tire particles will pass.

Improving the quality of the reaction products through additional processing of the solid product, and/or fractionating the liquid into more valuable products can also improve the overall economics of tire pyrolysis.

The inventors' experience with the only commercial operating recovered carbon black (“rCB”) plant in the world has suggested to them that the design of tire pyrolysis systems can be fundamentally improved. For various reasons, tires can be shredded in a step prior to pyrolysis. However, the prevalent reasoning in the industry is that a larger shred size results in a more economical pyrolysis process. It is believed that decreasing the shred size would significantly increase the cost of the overall process. For this reason, the industry employs relatively large shred sizes. In fact, some pyrolysis operations have attempted to process whole tires in order to eliminate the cost of shredding entirely.

Common practice in the industry utilizes rubber chips greater than 0.25 inches in diameter and less than 0.75 inches in diameter. It is believed that this optimizes the removal of wire while minimizing the cost of shredding.

While not intending to be bound by theory, it is believed that the vaporization of rubber during DEP is similar to the evaporation of rain drops falling from colder to warmer temperatures.

While not intending to be bound by theory, a lumped capacitance thermal model indicates that the time for a spherical particle to reach a given temperature when heated by an external source is proportional to the diameter of the particle.

It has been discovered that while the DEP process is much more efficient than conventional pyrolysis, the energy and concomitant CO₂ production may be further reduced by the invention described herein.

Accordingly, provided herein is a method of obtaining pyrolysis oil from rubber, comprising the steps of:
providing a feedstock, said feedstock comprising rubber;
milling the feedstock, thereby providing particles of the feedstock; and
pyrolyzing the particles in a vessel;
wherein the median size of the particles is from about 0.5 mm to about 15 mm, optionally from about 0.5 mm to about 12 mm, optionally from about 0.5 mm to about 9 mm, optionally from about 0.5 mm to about 6 mm. 15 mm or smaller, optionally 12 mm or smaller, optionally 9 mm or smaller, optionally 6 mm or smaller.

In some embodiments, the feedstock comprises a plurality of tires.

In some embodiments, the method further provides recovered carbon black (“rCB”).

### Abbreviations

DEP=depolymerization; DPL=depolymerization liquid; ELT=end-of-life tires; rCB=recovered carbon black; SrCB=sustainable recovered carbon black; TP=tire pyrolysis; TPO=tire pyrolysis oil; vCB=virgin carbon black.

The method is based on reducing and optimizing the size of the feedstock rubber particles. This is counter to the aforementioned trends towards increasing the size of feedstock pieces, in order to reduce shredding expenses.

In a preliminary step, waste tires may be buffed to separate the tread from the remainder of the tire. Separating the tread, carcass, sidewall and bead into individual feed streams may result in an increased value for the rCB, in particular due to the different composition of the rubber that is often used in the various parts of the tire.

The densification process begins with the fragmentation of the whole tire. Typically this is through shredding, although this may differ in some locations dependent on the scale of the tire supply and the cost of transportation. Other available options include chipping, grinding, milling, and freeze fracturing. The waste tire is fragmented into pieces several inches to less than a quarter inch in size, or from about 50 mm to about 13 mm in size. The size to which tires can be fragmented is, in general, without limitation. In some embodiments, tires can be fragmented to provide fragments with median size of 15 mm or smaller, optionally 12 mm or smaller, optionally 9 mm or smaller, optionally 6 mm or smaller.

As the size of the feedstock is reduced, the purity and quality of the resultant product is improved. A factor for this improvement is removal of the steel wire, fiber, and/or mineral content. A reduction in the feed rubber size allows wire, fiber, and mineral to be more effectively removed from the feedstock rubber. Smaller particles allow more complete separation and removal of polymer fibers and steel prior to the rubber entering the reactor. This is due to steel and fiber falling out of the smaller rubber particles. Steel can be separated by various means, including using magnetic separators. Steel can be removed by various means, including using magnetic separators. Fiber can be separated through density separation. For example, agitation of the rubber particles are agitated will cause the fiber float to the top, at which point they can be removed by vacuum. Alternately, a stream of air blown through the mixture will float the fiber, while the rubber will settle.

Removing wire and fiber helps eliminate the processing issues associated with introducing steel to the reactor and also improves the quality TPO by reducing sludge formation, from terephthalate and other polar compounds introduced into the vapor stream from the pyrolytic break-down of polymer fibers.

Removing wire will help eliminate processing issues due to its presence in the reactor, including but not limited to abrasion within the reactor caused by the wire, and from wire snarls, during the DEP process, thus reducing repair and operating costs.

Removing wire can also lower the energy required to grind the carbon product to the target size. It is understood that the milling of rCB to a size suitable for reincorporation into rubber products is both energy intensive and expensive, and can be a significant generator of CO₂ emissions. By starting with a finer rubber feedstock, it has been discovered that the carbon product exiting the reactor is finer and contains less residual rubber and char. Less grinding of the carbon product is thus required. This contributes to making the overall process more efficient compared to conventional technology currently in use, i.e., using larger size tire fragments. The overall energy requirements and concomitant production of CO₂ may thus be further reduced. Removal of fiber prior to pyrolysis can improve the overall process. Fiber in tires is typically composed of polyester or nylon. The fiber is decomposed by pyrolysis into chemicals that are insoluble in the liquid fraction, and cause sludge formation in this fraction upon cooling. This high boiling temperature sludge, primarily composed of terephthalate compounds and entrained carbon, is a source of buildup in the vapor condensing system and contaminates the tire pyrolysis oil (“TPO”). Centrifugation and filtration methods can be utilized to remove the sludge in the oil, albeit with difficulty. However, the overall process is made simpler, and therefore more efficient, by blocking the formation of sludge in the first place. Reducing the amount of fiber prior to pyrolysis can therefore improve the quality of the pyrolysis oil product.

The mineral components in the rubber may be removed by techniques such as density separation or acid treatment. These processes are also made more efficient with finer rubber particles. This is due to mineral particles falling out of the finer particles and a greater particle surface area to volume ratio, with many more particles existing close to the particle surfaces where they can be more easily removed. Reduction of the mineral content in rCB improves its value in applications such as tire reinforcing or in electrodes for batteries.

It will be appreciated that reduction in the amount of wire, fiber, or mineral in the tire feedstock will improve reactor throughput. At a given total feed rate, reducing the fraction that is fiber, steel, and/or mineral content will increase the production rate of rCB and TPO proportionally.

A catalyst may be blended into the reactor feed prior to entry of the fragmented rubber into the reactor. This sequence can improve the dispersion of the catalyst over the surface area of the rubber and enhance the effect of the catalyst on the pyrolysis process. Reducing the particle size of the rubber provides a greater surface area per unit volume, which further improves the efficiency of catalyst coating and interaction between the catalyst and the rubber. Furthermore, introduction of catalyst at this stage will reduce the aforementioned stress on the vacuum system that is otherwise caused by adding the catalyst separately from the rubber feedstock.

In some embodiments, the process may also comprise a step of preheating the rubber or rubber/catalyst mixture prior to the feed entering the reactor chamber.

At some point during heating, exothermic reactions are take place. The finer the feedstock particle size, the sooner this takes place in the reactor. The generation of heat from the exothermic reaction lowers the total energy addition required to heat and pyrolyze the waste tire. A result of the smaller fragment size is that the fragments have a larger surface/volume ratio. As a result, heat flow, either from an exothermic reaction or from external heating, can be faster and more uniform, thereby increasing the efficiency of the DEP process. Without intending to be bound by theory, the finer the feedstock particle size, the more efficient will be the heating of the particle. For this reason, these reactions will take place earlier in the pyrolysis process for smaller particles, thereby lowering the total energy input to the reactor required to heat the rubber particles.

A further advantage of utilizing smaller sized particles is that, all else being equal, the size distribution of the particles will be narrower than for larger sized particles. As a result, the risk of overheating of unusually small particles will be decreased. This can be significant, since overheating of rubber can lead to formation of inferior quality char which has lost most of the carbon nanostructure. This inferior char is less valuable both as a reinforcing agent in rubber and as a tinting agent in plastics. Pyrolysis of the smaller and more uniformly sized particles will afford a higher quality char.

During heating, some components in the rubber are volatilized or react to form new chemicals which may also volatilize. The volatile species are removed from the reactor sequentially or collectively, depending on the design of the reactor. These vapors are removed from the reactor sequentially or collectively depending on the design of the reactor. The vapors are condensed to a liquid which may be further processed to extract higher value components. Non-condensable species are typically flared or used to generate electricity.

The recovered carbon (rCB) is removed from the reactor when the volatiles are reduced to acceptable levels. The acceptable level of volatiles is preferably less than 10 wt %; more preferably less than 5 wt %; and even more preferably less than 3 wt %.

Depending on the target market, such as its use for battery electrodes, the rCB may be processed further via such techniques as acid washing and/or further reduced in size. The ultimate product may be preferably less than 100 μm; less than 20 μm more preferably; and even more preferably less than 10 μm.

### Improvements of the Disclosed Process

In contrast to existing practices in the field, using smaller feedstock particles allows the rubber to be pyrolyzed (depolymerized) faster and more efficiently with less heat input.

In contrast to existing practices in the field, using smaller feedstock particles takes advantage of the exothermic reaction undergone by heated tire chips to reduce the amount of external energy required to pyrolyze the rubber. This process further takes advantage of the increased exothermic reaction during heating generated by the addition of a catalyst.

In contrast to existing practices in the field, this process may selectively condense and separate the vapors generated during the pyrolysis process.

In contrast to existing practices in the field this process may separate the waste tire into tread buffings, carcasses, sidewalls, and bead rubber.

In contrast to existing practices in the field, this process encourages densification and shredding, chipping, or buffing at the earliest opportunity to reduce CO₂ emissions and create economic benefits, i.e., jobs.

In contrast to existing practices in the field, this process reduces the amount of non-carbon components, including steel, fiber, and heavies in the feedstock and provides an improved quality of recovered carbon black (rCB).

Processing finer particles may reduce buildup within the reactor (e.g., coking) and improve the quality of the TPO or DPL by reducing the amount of solids and high boiling point liquids (sludge) in the oil.

The process may be further improved by blending in a catalyst during the size reduction of the waste tire into fine particles.

The catalyst may also be added after the comminution process and prior to the rubber entering the reactor.

Blending of the catalyst during comminution of the waste tire will improve the dispersion of the catalyst over the surface area of the rubber and enhance the effect of the catalyst on the pyrolysis process in environments where the mixture is not exposed to high humidity.

The process may be further enhanced by preheating the rubber/catalyst mixture prior to the mixture entering the reactor chamber.

The system can be further improved by separation of polymer fibers by, e.g., density and steel by, e.g., magnetic separation at some point prior to the rubber entering the reactor.

The finer particle size precoated with catalyst helps to reduce the time and reactor temperature required to heat the rubber to a state where it naturally volatilizes.

Precoating of the rubber by catalyst reduces the opportunity for air leaks by having only one reactor feed point and permits lower flow rates in the vacuum system.

The use of the finer particle size precoated with catalyst reduces the overall input energy required to pyrolyze the particles.

One effect of adding the catalyst prior to entering the reactor is to reduce the opportunity for air to enter the reactor, thereby reducing air flow and energy required to maintain a given vacuum in the reactor and reducing the tendency for fine carbon to be drawn into the vacuum system.

The effect of removing the steel and fiber prior to pyrolysis or DEP is to improve the relative output of rCB and TPO/DPL from the process.

One effect of removing the steel and fiber is to reduce the abrasion in the reactor during the DEP process.

Another effect of removing the steel and fiber is to reduce the production of high boiling point liquids during the DEP process.

An effect of reducing the particle size is to allow greater throughput in a reactor of a given size.

Reducing the particle size allows smaller reactors to process a given particular amount of rubber.

The effect of reducing the particle size with the consequential reduction of reactor size is to also reduce the thermal stresses associated with larger reactors.

The effect of reducing the particle size is to reduce the vacuum needed to sweep the generated vapors from the reactor vessel. Lower air flow in the reactor reduces the entrainment of carbon particles into the vapor stream.

The effect of lower solids content in the vapor is to reduce the complexity of the condensation and liquid cleaning process.

Reducing the particle size increases the yield of rCB and DPL from waste tires.

The effect of reducing the particle size prior to DEP is to produce finer solids from the reactor with less residual rubber and char.

The effect of finer input particles is to reduce the energy required to reduce the output carbon to a size suitable for incorporation into rubber products.

The effect of all of the above is to minimize the CO₂ produced during processing of waste tires by optimizing energy use over the entire waste tire to rCB+TPO process rather than the individual operations separately.

The presence of residual steel or fiber in the rubber is known to interfere with the operation of the reactor and condensing system.

Air leakage in the reactor is a source of lost production and higher energy costs and causes carryover of solids in the vapor stream.

Reduction of particle size can be a means of reducing the reactor size and the total energy required to DEP rubber.

Blending of a catalyst with finer particles during the reduction process or otherwise prior to the rubber entering the reactor can further improve the efficiency of the process.

Removal of the fiber can improve the quality of the DPL produced.

The DEP of finer rubber particles can reduce the energy required to mill the product rCB to an appropriate particle size for reincorporation into rubber.

Reduction of the feed particle size can allow for the design of more innovative, lower cost reactors.

While not intending to being bound by theory, it is believed that the reduction of energy consumption by the reactor and CO₂ production will decrease at least linearly with the maximum feed particle size as the feed particle size is reduced.

While not intending to being bound by theory, it is believed that pre-blending of the catalyst with the size reduced rubber, preferably during a shaker table operation during shredding, will increase the effectiveness of the catalyst and further reduce the energy and time required to process the rubber.

### EXAMPLES

### Example 1—Lumped Capacitance Modeling

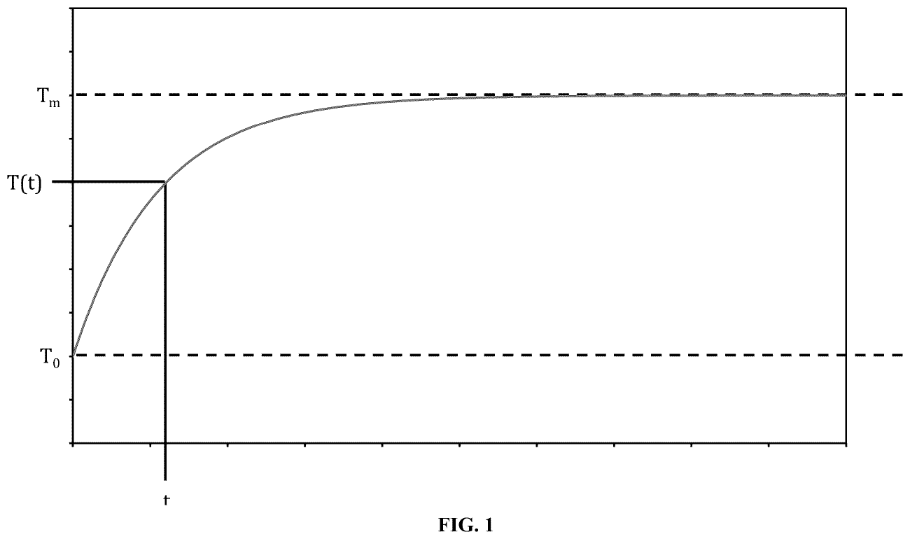

A mathematical model (Lumped Capacitance Model) was applied to compare the times needed to heat a single solid particle from temperature, T₀, to a target temperature, Tₜ, when placed in a nitrogen environment of constant temperature. The model is depicted graphically in FIG. 1. This model demonstrated the differing heating rates based on particle diameter. Results showed that 6 mm particles heated 3 times faster to a given temperature than 20 mm particles. This model only provides a relative comparison and does not include mixing and heat transfer parameters as found in an actual reactor system.

### Example 2—Finite Element Model—Single Particle Heating

A particle in an indirectly heated pyrolysis reactor is heated by collisions with hot reactor surfaces, other hot particles, and hot gases and vapors. In a completely unmixed system, the rate of heat transfer depends on the thermal properties of the material and the nature of the contact with hot surfaces. Particle properties such as size and surface to volume ratio do not have a strong effect on the overall heating rate of an unmixed system. By contrast, in a well-mixed system, particles are heated by a uniform heat flux through the particle surface, and particle size has a strong effect on the overall heating rate. This is demonstrated by using a finite element model to simulate the heating rate of spherical particles of varying size.

A simulation was conducted using Elmer FEM open-source multi-physical simulation software and finite element methods. Spherical rubber particles of varying diameters were set to an initial temperature of 300° K with a fixed, 700° K temperature boundary condition on the surface of the sphere. Relevant modeling parameters included specific heat capacity, thermal conductivity, and density. These were set to 2000 J/kg-K, 0.38 W/m K, and 1190 kg/m3, respectively.

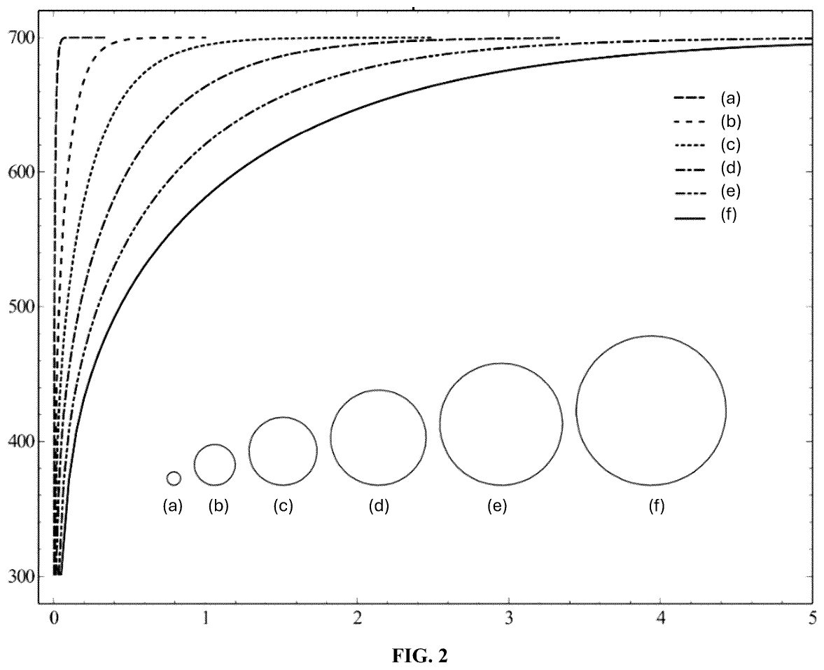

The average particle temperature reached 690° K (10 degrees less than the surface temperature) within 2, 19, 51, 100, 166, and 249 seconds for particles with diameters of 2, 6, 10, 14, 18, and 22 mm, respectively. These results show that the heating of a well-mixed system depends strongly on the particle size. According to this evaluation, a factor of approximately 3.5 reduction in diameter from 22 to 6 mm equates to approximately a 13-fold reduction in the heating time of the particles. This is shown graphically in FIG. 2. This methodology will provide a best-case scenario for heating spherical particles of different diameters.

### Example 3—Finite Element Model—Single Particle Heating

The research in Example 3 was supported in part by the University of Pittsburgh Center for Research Computing, RRID:SCR_022735, through the resources provided. Specifically, this work used the H2P cluster, which is supported by NSF award number OAC-2117681.

The mixing and heat transfer of a commercial auger system was modeled using a combination of computational fluid dynamics (CFD) and the discrete element method (DEM) coupled through the open-source CFDEM® framework using LIGGGHTS® for the DEM calculations. The simulated auger geometry, atmosphere, and temperatures are similar to a currently used commercial system. For practical reasons, only the first 2 meters of the reactor and 250 seconds of reaction time were modeled. Both 6 mm and 20 mm particles were simulated. The reactor wall was set to a fixed temperature of 700 K, the auger temperature was set to 589 K, and the atmosphere was simulated as nitrogen at a partial vacuum of 10 inches Hg.

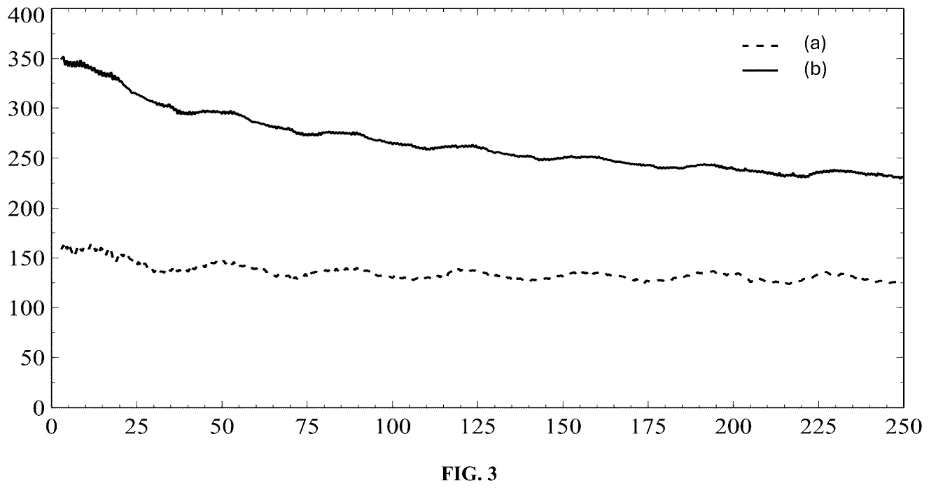

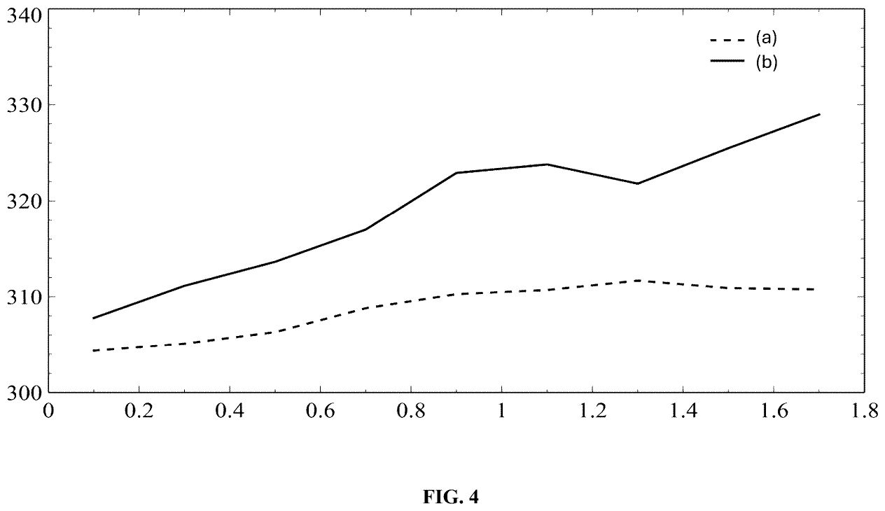

This model demonstrated that the simulated reactor can deliver approximately twice the heat flux per unit mass to the 6 mm particles relative to the 20 mm particles. This is depicted graphically in FIG. 3. FIG. 4 illustrates how this difference in heat flux corresponds to a difference in the average particle temperature. On average, the 6 mm particles are approximately 20 K hotter than the 20 mm particles after travelling 1.9 meters through the auger. Doubling the heat flux will allow a shorter reactor to be utilized or will allow the reactor throughput to be increased.

All publications and patents referred to herein are incorporated by reference. Whereas particular embodiments of this invention have been described herein for purposes of illustration, it will be evident to those skilled in the art that numerous variations of the details of the present invention may be made without departing from the invention as defined in the appended claims.

1. A method of obtaining pyrolysis oil from rubber, comprising the steps of:
providing a feedstock, said feedstock comprising rubber;
milling the feedstock, thereby providing particles of the feedstock; and
pyrolyzing the particles in a vessel;
wherein the median size of the particles is from about 0.5 mm to about 15 mm, optionally from about 0.5 mm to about 12 mm, optionally from about 0.5 mm to about 9 mm, optionally from about 0.5 mm to about 6 mm, optionally 15 mm or smaller, optionally 12 mm or smaller, optionally 9 mm or smaller, or optionally 6 mm or smaller.

2. The method of claim 1, wherein the median size of the particles is from about 0.5 mm to about 9 mm.

3. The method of claim 1, wherein the pyrolysis step is performed in the presence of a catalyst.

4. The method of claim 3, wherein the catalyst comprises a clay.

5. The method of claim 4, wherein the clay is chosen from bentonite, montmorillonite, and beidellite.

6. The method of claim 3, wherein the catalyst comprises a metal dust.

7. The method of claim 6, wherein the metal dust comprises aluminum or magnesium.

8. The method of claim 3, further comprising the step of mixing the catalyst with the feedstock prior to milling the feedstock.

9. The method of claim 3, further comprising the step of mixing the catalyst with the particles prior to introduction of the particles into the vessel.

10. The method of claim 1, wherein the particles reach a target temperature at a rate that is 200% or faster, optionally 300% or faster, optionally 400% or faster, than the corresponding rate for 20 mm particles.

11. The method of claim 1, wherein the pyrolysis step is performed with an auger.

12. The method of claim 11, wherein the heat flux is 125% or faster, optionally 150% or faster, optionally 200% or faster, than the corresponding rate for 20 mm particles.

13. The method of claim 1, wherein the feedstock comprises a plurality of tires.

14. The method of claim 1, wherein the method further provides recovered carbon black (“rCB”).

15. The method of claim 13, further comprising the step of removing polymer fiber from the feedstock subsequent to the step of milling the feedstock.

16. The method of claim 15, wherein 70% or more of the polymer fiber is removed from the feedstock, optionally 80% or more, optionally 90% or more.

17. The method of claim 15, wherein between 70% and 95% of the polymer fiber is removed from the feedstock, optionally between 80% and 95%, optionally between 85% and 95%.

18. The method of claim 15, wherein polymer fiber is removed using density separation.

19. The method of claim 13, further comprising the step of separating a component of the tire chosen from the tread, the sidewall, and the inner liner, subsequent to the step of milling the feedstock.

20. The method of claim 19, wherein the component of the tire is the tread.

21. The method of claim 20, wherein the step of separating the tread is performed using buffing.

22. The method of claim 13, further comprising the step of removing metal wire subsequent to the step of milling the feedstock.

23. The method of claim 22, wherein the metal wire comprises steel.

24. The method of claim 23, wherein the metal wire is removed using magnetic separation.

25. The method of claim 13, further comprising the step of removing one or more minerals subsequent to the step of milling the feedstock.

26. The method of claim 13, wherein the one or minerals comprise compounds or oxides of sulfur, zinc sulfide, calcium, titanium, or a mixture thereof.

27. The method of claim 26, wherein minerals are removed using density separation or treatment with an acid.

28. The method of claim 27, wherein the acid is a mineral acid.

29. The method of claim 28, wherein the mineral acid is chosen from hydrochloric acid, sulfuric acid, and nitric acid.
